(19) United States
(12) Patent Application Publication
(10) Pub. No.: US 2007/0083731 A1
(43) Pub. Date: Apr. 12, 2007

(54) Processor automatically performing processor ID setting and path setting and method of configuring multiprocessor

(75) Inventor: Seiichiro Kihara, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/522,986

(22) Filed: Sep. 19, 2006

(30) Foreign Application Priority Data
Sep. 20, 2005 (JP) 2005-271751(P)
Feb. 20, 2006 (JP) 2006-042357(P)

(51) Int. Cl. G06F 15/00

(52) U.S. Cl. 712/11

(57) ABSTRACT

An ID determining portion determines a self processor ID according to an input port name receiving a control instruction and a sender processor ID stored in the received control instruction. The control instruction storing the self processor ID is output from each output port via a diverging portion. Therefore, the processor ID of each processor can be automatically determined during initializing processing.

This nonprovisional application is based on Japanese Patent Applications Nos. 2005-271751 and 2006-042357 filed with the Japan Patent Office on Sep. 20, 2005 and Feb. 20, 2006, respectively, the entire contents of which are hereby incorporated by reference.

### BACKGROUND OF THE INVENTION

1. Field of the Invention

The present invention relates to a technique of configuring a multiprocessor by mutually connecting input/output ports of processors, and particularly to a processor automatically performing of processor ID setting and path setting that are required for achieving transmission and reception of data between processors as well as a method of configuring a multiprocessor.

2. Description of the Background Art

In recent years, it has been demanded to improve processor performance in various fields, e.g., of multimedia processing and high-definition image processing that require fast processing of a large quantity of data. However, the present LSI (Large Scale Integrated circuit) manufacturing technology can improve operation speeds of devices only to a limited extent. Therefore, attention is being given to parallel processing, and research and development of the parallel processing have been actively made.

Among computer architectures for the parallel processing, attention is being given particularly to a data-driven-type architecture. In the data-driven-type processing method, processing is performed in parallel according to rules that the processing is performed when all input data required for the processing are prepared and required resources such as operation units assigned to the processing.

The data-driven-type processor (which may be simply referred to as the “processor” hereinafter) can be used for providing a multiprocessor formed of many processors by connecting an output port of each processor to an input port of another processor. By changing path setting inside the processor, a connection relationship between the processors can be changed, which is another feature of the data-driven-type processor. Japanese Patent Laying-Open No. 5-314284 is a reference relating to the above data-driven-type processor.

FIG. 1 illustrates an example of a conventional multiprocessor formed of a plurality of data-driven-type processors connected together. This multiprocessor includes four data-driven-type processors 100-0-100-3 connected in a grid-like fashion. More specifically, an output port of processor 100-0 is connected to an input port of processor 100-1, of which output port is connected to an input port of processor 100-2. An output port of processor 100-2 is connected to an input port of processor 100-3, of which output port is connected to an input port of processor 100-0.

Processor 100-0 has another input port 101 receiving path information provided by an initial program loader (which may also be referred to as an “IPL” hereinafter), and processor 100-1 has another output port 102 connected to a processor (not illustrated).

Processor IDs of processors 100-0-100-3 are set by DIP switches. The processor ID “0” is set in processor 100-0, and the processor ID “1” is set in processor 100-1. The processor IDs of “2” and “3” are set in processors 100-2 and 100-3, respectively. Output port 102 of processor 100-1 is connected to a processor (not illustrated) having a processor ID of “4”.

In the multiprocessor having the above connection structure, the IPL provides the path information via input port 101 of processor 100-0, and thereby the path information is set in the output port select register (which will be referred to as an “OPS register” hereinafter) of each processor. Input port 101 is connected to a host computer (not illustrated).

The OPS register has a 16-bit structure, in which a zeroth bit corresponds to a processor of the processor ID “0”, and a first bit corresponds to a processor of the processor ID “1”. Similarly, the subsequent bits correspond to processors of processor IDs of “2”-“15”, respectively.

When the bit corresponding to each processor is “0”, an OA port is selected. When it is “1”, an OB port is selected. Thereby, a packet is output. For example, “0x000D” is set in the OPS register of processor 100-1 of the processor ID “1”, a packet is output to the processor of processor ID “4” via output port 102 (OA port), and a packet is output to each of processors of processor IDs of “0”, “2” and “3” via the OB port.

FIG. 2 illustrates an example of a data packet of a conventional data-driven-type processor. This data packet has a 32-bit and 2-word structure, and includes a host transfer flag (HST), a control flag (CTL), a instruction execution target processor number (PE#) of 4 bits, an entry number (Entry#) of 6 bits, a generation number (GE#) of 20 bits and a data field (DATA) of 32 bits.

The host transfer flag and the control flag are fields storing flags indicating types of the packet. The instruction execution target processor number is a field storing the ID of the destination processor. The entry number is a field storing the address of the program memory arranged in the processor. The generation number is a field storing the data ID assigned to the data packet. The data is a field storing the data body.

Description will now be given on the case where the data packet illustrated in FIG. 2 is input via input port 101 illustrated in FIG. 1, and the instruction execution target processor number (PE#) in the data packet is set to “3”.

When the data packet is input to processor 100-0 via input port 101, the data packet is output based on the setting of the OPS register from output port OB which is a destination of the instruction execution target processor number “3”, and is input into processor 100-1 via the input port.

When the data packet is input to processor 100-1, the data packet is output based on the setting of the OPS register from output port OB which is a destination of the instruction execution target processor number “3”, and is input into processor 100-2 via the input port.

When the data packet is input into processor 100-2, the data packet is output based on the setting of the OPS register from output port OB which is the output destination of the instruction execution target processor number “3”, and is input into processor 100-3 via the input port. In this manner, the data packet reaches processor 100-3 of the instruction execution target processor number “3”, and processor 100-3 fetches an operation code of a program memory indicated by the entry number included in the data packet, and internally executes the instruction.

Description will now be given on the case where the data packet illustrated in FIG. 2 is likewise input via input port 101 illustrated in FIG. 1, and the instruction execution target processor number in the data packet is set to “4”.

First, when the data packet is input into processor 100-0 via input port 101, the data packet is output based on the setting of the OPS register from output port OB that is the output destination of the instruction execution target processor number “4”, and is input into processor 100-1 via the input port.

When the data packet is input to processor 100-1, the data packet is output based on the setting of the OPS register from output port OA (output port 102) that is the output destination of the instruction execution target processor number “4”.

In not only the data-driven-type processor but also other multiprocessors, it is not allowed to assign overlapping processor IDs to the processors forming the multiprocessor, and therefore such a manner is employed that the processor IDs are manually set with DIP switches as already described, are fixed by interconnection patterns on mounted boards or are set by reading the processor IDs from an external ROM in an initializing operation. Accordingly, it is difficult to cope with changes in multiprocessor structure already mounted.

The path selection for performing communications with another connected processor depends on the processor IDs assigned to the respective processors. Therefore, when the processor ID must be changed, e.g., due to addition of a processor in a later stage, the setting for the path selection must be performed again from the beginning, which results in another problem.

When a failure occurs in the processor forming the multiprocessor, the failed processor must be repaired for operating the multiprocessor without difficulty, which is still another problem.

### SUMMARY OF THE INVENTION

An object of the invention is to provide a processor that can automatically determine a processor ID of the processor in an initializing operation as well as a multiprocessor forming method.

Another object of the invention is to provide a processor that does not require reselection of a path even after change of a processor ID as well as a multiprocessor forming method.

Still another object of the invention is to provide a processor that can transmit a data packet while detouring an output port not connected to a processor, or detouring an output port connected to a failed processor and the like as well as a multiprocessor forming method.

According to an aspect of the invention, a processor forming a multiprocessor includes at least one set of input/output ports; an identifier determining portion determining a self processor identifier based on a processor identifier of a first different processor connected to the input port provided from the first different processor; and an operation processing portion performing an operation on data included in a data packet of a destination of the self processor identifier determined by the identifier determining portion, and producing a data packet including a result of the operation. The output port provides the data packet produced by the operation processing portion to a second different processor connected to the output port.

Therefore, the processor identifier of the processor can be automatically determined during the initializing.

Preferably, the processor includes two sets of input/output ports, the identifier determining portion determines the self processor identifier based on the processor identifier of the first different processor and information specifying the input port selected from between the two ports for inputting the processor identifier of the first different processor.

Therefore, the processor can accurately determine the self processor identifier.

Preferably, the processor further includes an output determining portion determining the output port to be selected from between the two output ports for outputting the data packet, based on the self processor identifier and the destination processor identifier included in the data packet.

Therefore, it is not necessary to perform the path selection again even when the processor identifier is changed.

Preferably, the processor further includes a storing portion storing information indicating whether each of the two output ports is connected to a different processor or not, and when the output determining portion determines according to the information stored in the storing portion that the output port selected for outputting the data packet is not connected, the output determining portion outputs the data packet via the other output port.

Therefore, the data packet can be transmitted while detouring the output port not connected to the processor.

More preferably, when the output determining portion determines that the different processor connected to the output port is failed, the output determining portion stores, in the storing portion, information indicating that the output port connected to the different processor is not connected.

Therefore, the data packet can be transmitted while detouring the failed processor.

Preferably, the processor further includes a storing portion storing information indicating whether each of the two output ports is connected to the different processor or not, and the output determining portion transmits a packet indicating an error to the processor of the sender when the output determining portion refers to the storing portion and determines that the output port connected to the processor of the destination of the data packet is not connected.

Therefore, the processor of the sender can perform error correction processing.

Preferably, the processor further includes a storing portion storing information indicating whether each of the two output ports is connected to the different processor or not, and the output determining portion transmits a packet indicating an error to a predetermined processor when the output determining portion refers to the storing portion and determines that the output port connected to the processor of the destination of the data packet is not connected.

Therefore, the predetermined processor can perform the error correction processor in a concentrated fashion.

According to another aspect of the invention, a multiprocessor forming method for forming a multiprocessor by connecting a plurality of processors each having at least one set of input/output ports, includes the steps of causing a first processor to determine a self processor identifier of the first processor based on a processor identifier of a second processor received from the second processor connected to the input port of the first processor; and causing the first processor to transmit the determined self processor identifier to a third processor connected to the output port of the first processor.

Therefore, the processor identifier of each processor forming the multiprocessor can be automatically determined.

Preferably, the multiprocessor includes a multiprocessor at a first level formed of annularly connected four processors each having two sets of input/output ports and a multiprocessor at a second level formed of the annularly connected four multiprocessors at the first level, and has a hierarchical structure of units of 4^{N} in number, where N is an integer larger than 0.

Addition of a processor to the multiprocessor can be readily performed.

Further preferably, the position of the processor included in the multiprocessor at the first level is represented by 2 bits, the position of the multiprocessor at the first level included in the multiprocessor at the second level is represented by 2 bits, and the processor identifier of the multiprocessor at the Nth level is represented by (2×N) bits.

Therefore, the processor identifier of the processor can be readily set.

Further preferably, each of the processors forming the multiprocessor determines a destination direction by successively making a comparison between the self processor identifier and the destination processor identifier included in the received packet in a direction from an upper level to a lower level, and determines the output port according to the destination direction and the value at the first level of the self processor identifier.

Therefore, the information for determining the destination direction can be reduced even when the levels of the processors increase in number.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an example of a multiprocessor including a plurality of conventional data-driven-type processors connected together.

FIG. 2 illustrates an example of a data packet of the conventional data-driven-type processor.

FIG. 3 is a block diagram illustrating a schematic structure of a data-driven-type processor in a first embodiment of the invention.

FIG. 4 illustrates an example of connection of four processors each illustrated in FIG. 3.

FIG. 5 illustrates an example of connection of a multiprocessor including four connected processors each illustrated in FIG. 3.

FIG. 6 illustrates an example of a multiprocessor including 16 processors each illustrated in FIG. 3.

FIG. 7 illustrates an example of a structure of a control packet used for determining a processor ID.

FIG. 8 illustrates a state where a processor 1-0 receives a control instruction A.

FIG. 9 illustrates a state where a processor ID “0” is set in processor 1-0.

FIG. 10 illustrates a state where processor 1-0 of processor ID “0” outputs a control instruction B from its output port.

FIG. 11 illustrates an example of a structure of an ID determining portion 12.

FIG. 12 illustrates an example of a table used for determining the processor ID by ID determining portion 12.

FIG. 13 illustrates a state where a processor ID “1” is set in processor 1-1.

FIG. 14 illustrates a state where processor 1-1 of processor ID “1” outputs a control instruction B from its output port.

FIG. 15 illustrates a state where a processor ID “2” is set in processor 1-2.

FIG. 16 illustrates a state where processor 1-0 abandons control instruction B.

FIG. 17 illustrates an example of a structure of an output determining portion 19.

FIG. 18 illustrates an example of a truth table used for selecting the output port.

FIG. 19 illustrates a state of connection of the output ports of the respective processors.

FIG. 20 is a flowchart for illustrating processing steps of output determining portion 19 in a second embodiment of the invention.

FIG. 21 illustrates an example of a truth table used for determining a destination direction.

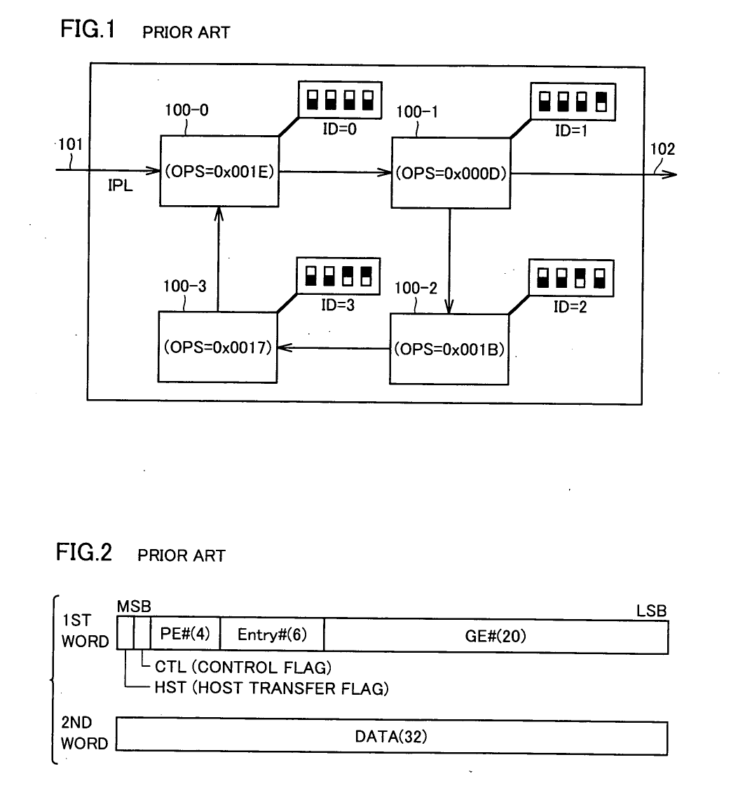

### DESCRIPTION OF THE PREFERRED EMBODIMENTS

(First Embodiment)

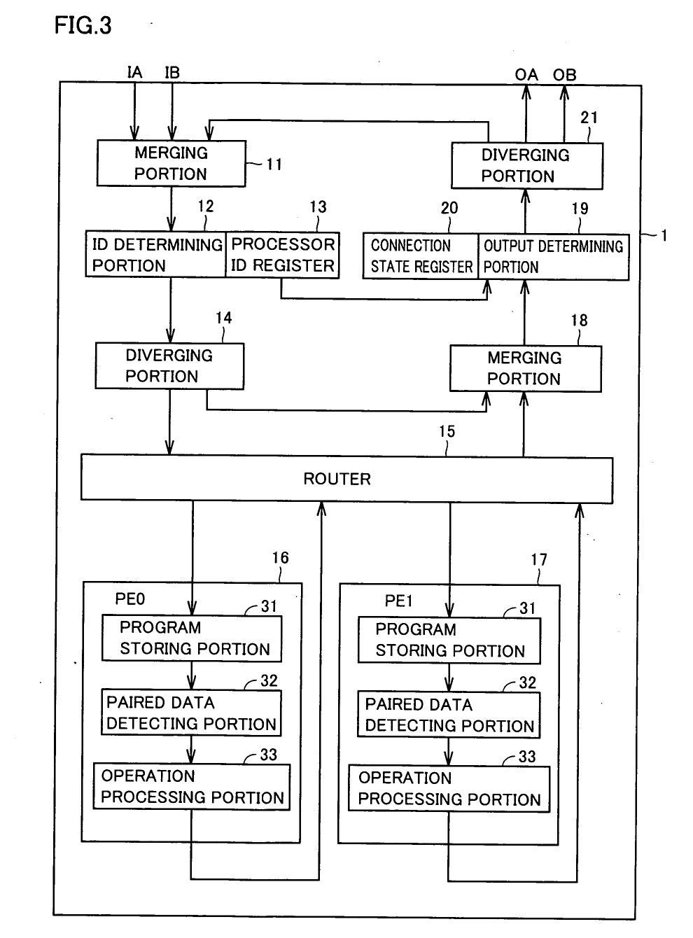

FIG. 3 is a block diagram illustrating a schematic structure of a data-driven-type processor of a first embodiment of the invention. The processor includes a merging portion 11, an ID determining portion 12 determining a self processor ID, i.e., a processor ID of this processor, a processor ID register 13 storing the processor ID, a diverging portion 14, a router 15, a PE0 (Processor Element 16), a PE1 (Processor Element 17), a merging portion 18, an output determining portion 19 determining or specifying an output port for outputting a data packet, a connection state register 20 storing a connection state of the output port, and a diverging portion 21. Although this embodiment employs the two processor elements (PE0 and PE1), the number of them is not restricted.

Each of PE0 and PE1 includes a program storing portion 31, a paired data detecting portion 32 and an operation processing portion 33.

Merging portion 11 receives data packets from input ports 1A and 1B as well as diverging portion 21, arranges the data packets in a predetermined order and provides them to ID determining portion 12. ID determining portion 12 determines the self processor ID in a method that will be described later, and stores this processor ID in processor ID register 13.

Diverging portion 14 refers to an instruction execution target processor number of the data packet provided from merging portion 11, and determines whether the data packet is to be processed internally by the processor. When it is determined that the data packet is to be processed internally by the processor, the data packet is provided to router 15. When it is determined that the data packet is to be processed by another, i.e., different processor, the data packet is provided to merging portion 18.

Router 15 receives the data packet from diverging portion 14, and provides it to PE0 (16) or PE1 (17) according to its destination. Router 15 provides the data packet received from PE0 (16) or PE1 (17) to merging portion 18.

Program storing portion 31 adds a necessary operation instruction and a node number to a data packet received from router 15, and produces a data packet formed of a predetermined bit field for providing it to paired data detecting portion 32.

When paired data detecting portion 32 receives the data packet from program storing portion 31, it performs queuing until two data packets to be arithmetically or logically processed are present, and will provide these data packets to operation processing portion 33 when these become complete.

Operation processing portion 33 executes an operation such as an arithmetic or logic operation on the data included in the two data packets according to the operation instruction that is included in the data packet received from paired data detecting portion 32, stores a result of this operation in the data packet that is assigned the instruction execution target processor number, and provides it to router 15.

Merging portion 18 receives the data packets from diverging portion 14 and router 15, rearranges the data packets in a predetermined order and provides them to output determining portion 19.

Output determining portion 19 refers to connection state register 20, determines output port OA or OB, to which the data packet is to be provided, in a method that will be described later, and provides an instruction about it to diverging portion 21.

Diverging portion 21 provides the data packet received from merging portion 18 to output port OA or OB according to the instruction of output determining portion 19. When the instruction execution target processor number included in this data packet is equal to the processor number of this processor, diverging portion 21 provides the data packet to the merging portion 11.

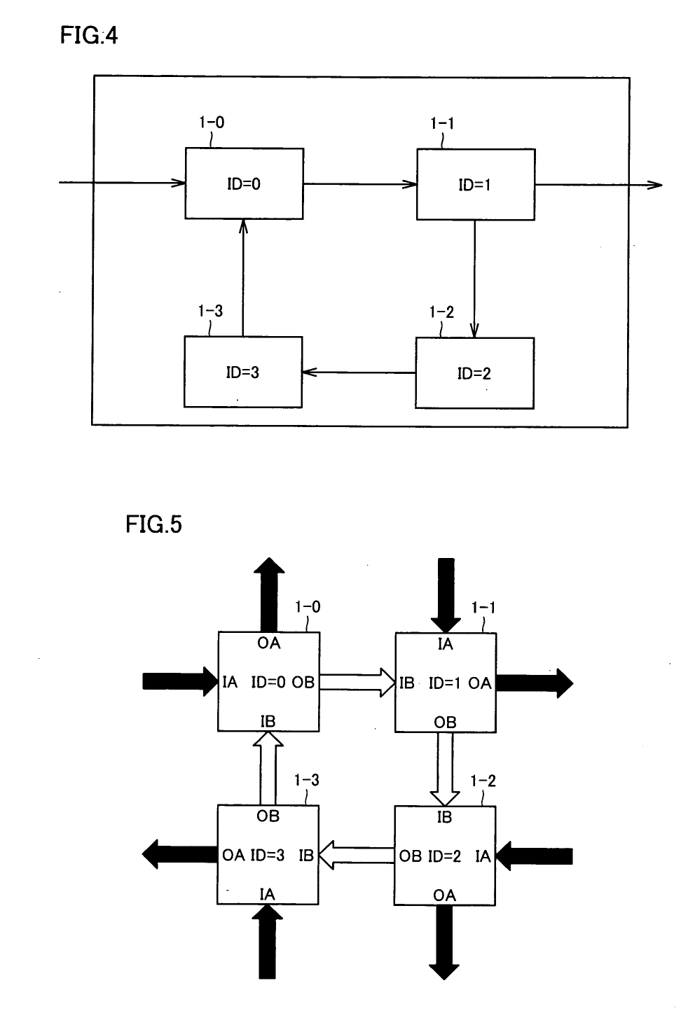

FIG. 4 illustrates an example of the connection of four processors each illustrated in FIG. 3. Four processors 1-0-1-3 that correspond to processor IDs of “0”-“3”, respectively, are connected in a loop fashion.

FIG. 5 illustrates an example of the connection of the multiprocessor in which four processors each illustrated in FIG. 3 are connected. Output port OB of processor 1-0 of the processor ID “0” is connected to an input port IB of processor 1-1 of the processor ID “1”. Output port OB of processor 1-1 of the processor ID “1” is connected to an input port IB of processor 1-2 of the processor ID “2”. Output port OB of processor 1-2 of the processor ID “2” is connected to an input port IB of processor 1-3 of the processor ID “3”. Output port OB of processor 1-3 of the processor ID “3”, is connected to an input port IB of processor 1-0 of the processor ID

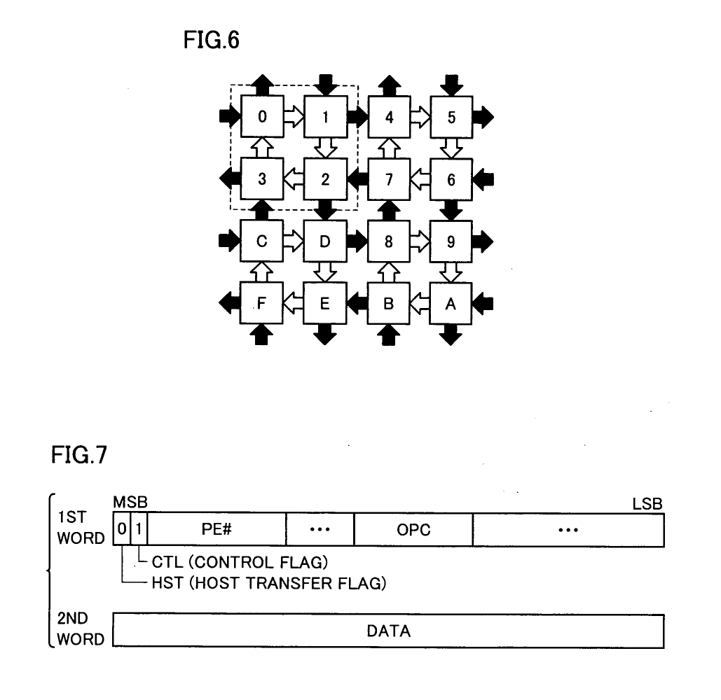

FIG. 6 illustrates an example of a multiprocessor in which 16 processors each illustrated in FIG. 3 are connected. For forming the multiprocessor having 16 processors as illustrated in FIG. 6, four multiprocessors (first level) each having four processors illustrated in FIG. 5 are combined to form a second level. In FIG. 6, a portion surrounded by dotted line corresponds to the multiprocessor at the first level illustrated in FIG. 5. The four multiprocessors at the first level have the same connection structures. A multiprocessor having units of 4^{N} (N=1, 2, 3, . . . ) in number can be achieved by the same or substantially the same connection structures.

For example, a multiprocessor may have a hierarchical structure configured, e.g., such that four multiprocessors at a first level form a second level, and four multiprocessors at the second level form a multiprocessor at a third level. In this configuration, the positions of the processors or multiprocessors in each level are represented by two bits, and 2-bit data of each level is coupled to the others to use the result as the processor ID. In this manner, the multiprocessor of the 4^{N} units (N=1, 2, 3, . . . ) can be readily formed.

Description will now be given on the method of determining the processor ID of each processor. Although the processor IDs are described in FIGS. 4-6, these descriptions represent that these processor IDs will be determined later, and are not yet determined immediately after connection of the processors.

FIG. 7 illustrates an example of a structure of a control packet used when determining the processor ID. The control packet has a 32-bit and 2-word structure, and includes a host transfer flag (HST), a control flag (CTL), an instruction execution target processor number (PE#), an operation code (OPC) and a data field (DATA). In this control packet, the OPC field bears instructions for performing read/write of the data from or into a register in the processor or a program memory of an internal processor, and for reading data from a ROM.

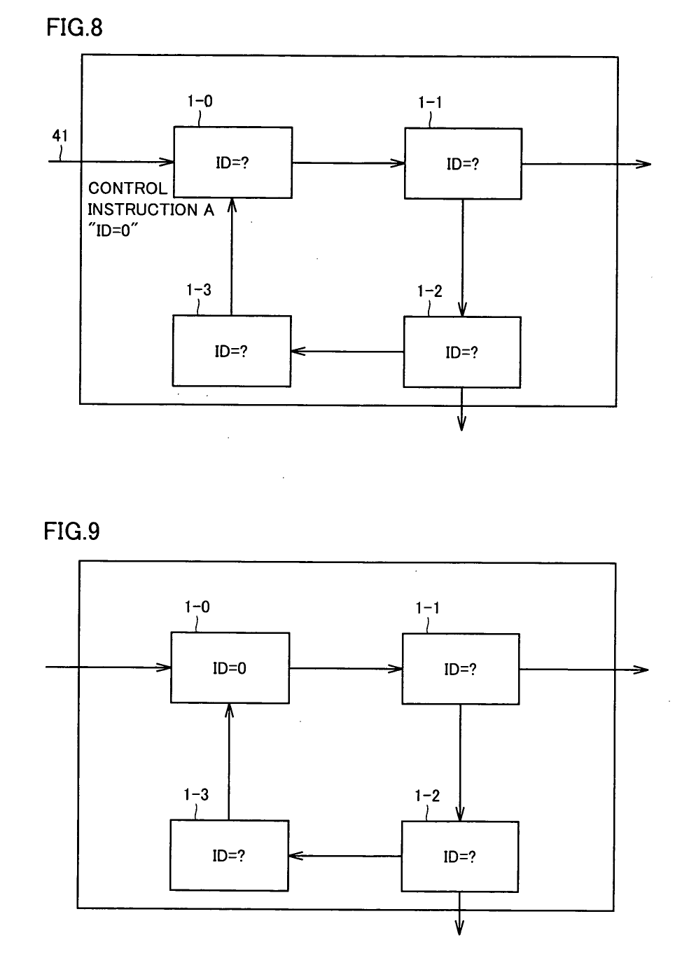

FIG. 8 illustrates a state where a control instruction A is provided to processor 1-0. Control instruction A is provided via an input port 41 to processor 1-0. This control instruction A sets “0” stored in the data field as the processor ID.

FIG. 9 illustrates a state where the processor ID “0” is set in processor 1-0. When ID determining portion 12 in processor 1-0 receives control instruction A via merging portion 11, it recognizes that the processor ID of this processor is “0”, and set “0” in processor ID register 13.

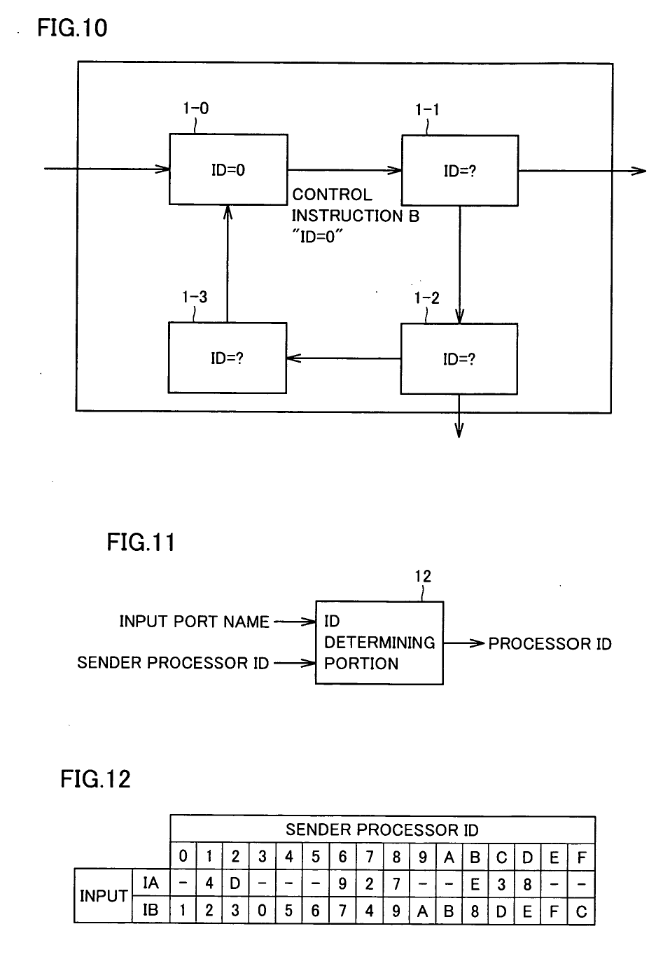

FIG. 10 illustrates a state where processor 1-0 of processor ID “0” provides a control instruction B to its output port. When ID determining portion 12 of processor 1-0 receives control instruction A, it stores the processor ID of “0” in control instruction B, and outputs it. Control instruction B is provided to the neighboring processor via diverging portion 14, merging portion 18 and diverging portion 21 from the output port thereof

FIG. 11 illustrates an example of a structure of ID determining portion 12. ID determining portion 12 refers to a table held therein, and determines the self processor ID, i.e., the processor ID of this processor according to the input port name receiving control instruction B and the sender processor ID stored in received control instruction B.

FIG. 12 illustrates an example of a table used for determining the processor ID by ID determining portion 12. For example, when the name of input port receiving control instruction B is IB, and the sender processor ID is “0”, the processor ID “1” is determined for this processor. This table may be achieved by a ROM or a logic circuit.

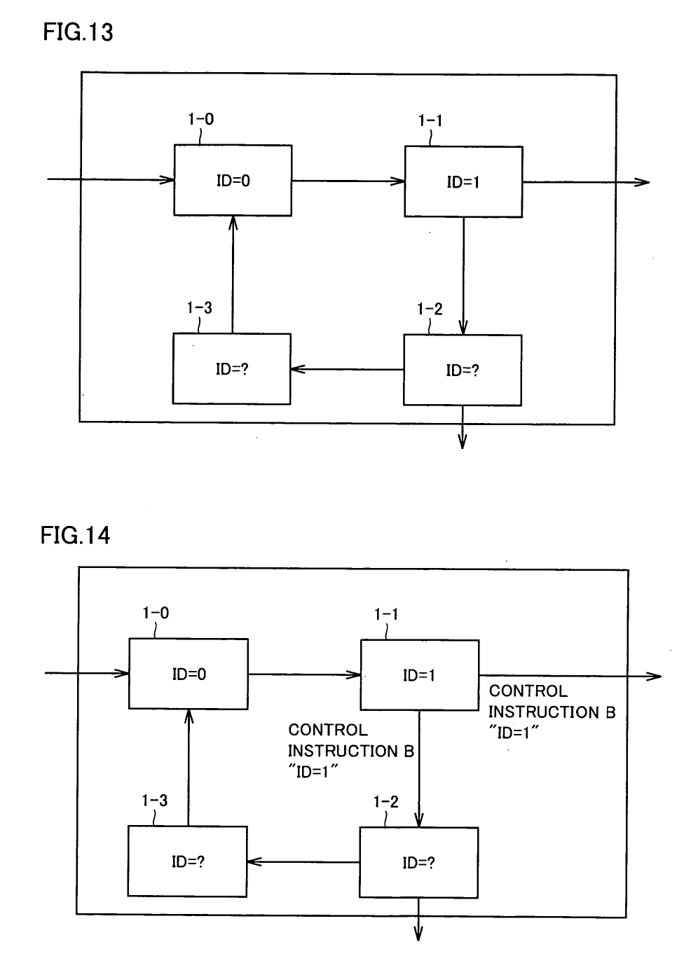

FIG. 13 illustrates a state where the processor ID “1” is set in processor 1-1. When ID determining portion 12 in processor 1-1 receives control instruction A via merging portion 1 1, it recognizes with reference to the table of FIG. 12 that the processor ID of this processor is “1”, and “1” is set in processor ID register 13.

FIG. 14 illustrates a state where control instruction B is provided to the output port of processor 1-1 of the processor ID “1”. When ID determining portion 12 of processor 1-1 determines the processor ID thereof, it stores the processor ID “1” in control instruction B for output. Control instruction B is provided via diverging portion 14, merging portion 18 and diverging portion 21 from the output ports thereof to the neighboring processor. As illustrated in FIG. 6, when output port OA of the processor of processor ID “1” is connected to the processor of processor ID “4”, control instruction B is provided to both processor 1-2 of processor ID “2” and the processor of processor ID “4”.

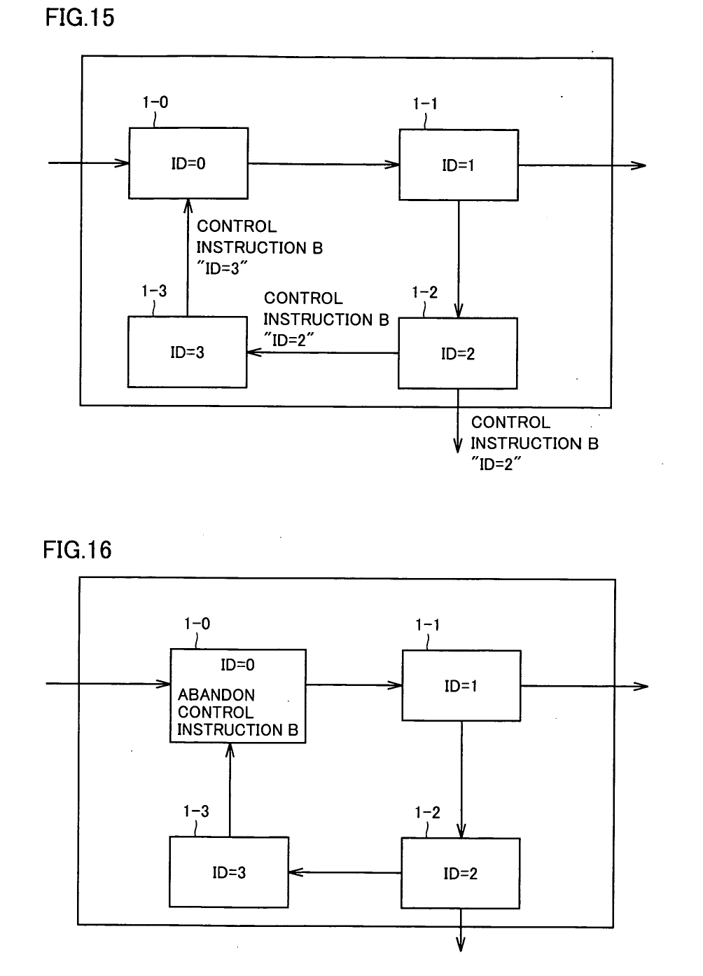

FIG. 15 illustrates a state where the processor ID “2” is set in processor 1-2. When ID determining portion 12 in processor 1-2 receives control instruction B via merging portion 11, it recognizes with reference to the table in FIG. 12 that the processor ID of this processor is “2”, and “2” is set in processor ID register 13. The processor ID “2” is stored in control instruction B and is output. Control instruction B is output via diverging portion 14, merging portion 18 and diverging portion 21 from the output thereof to the neighboring processor. As illustrated in FIG. 6, when output port OA of the processor of the processor ID “2” is connected to the processor of the processor ID “D”, control instruction B is provided to both processor 1-3 of processor ID “3” and the processor of processor ID “D”.

When ID determining portion 12 in processor 1-3 receives control instruction B via merging portion 11, it recognizes with reference to the table in FIG. 12 that the processor ID of its processor is “3”, and sets “3” in processor ID register 13. Processor ID “3” is stored in control instruction B, and is output. Control instruction B is output via diverging portion 14, merging portion 18 and diverging portion 21 from the output port thereof to the neighboring processor. In this manner, the processor IDs of all the processors are determined.

FIG. 16 illustrates a state where control instruction B is being abandoned in processor 1-0. Processor 1-0 receives control instruction B from processor 1-3, but abandons control instruction B because the self processor ID, i.e., its own processor ID is already determined. This operation can prevent unnecessary issuance of control instruction B for determining the processor ID, and can end the processing operation for determining the processor ID.

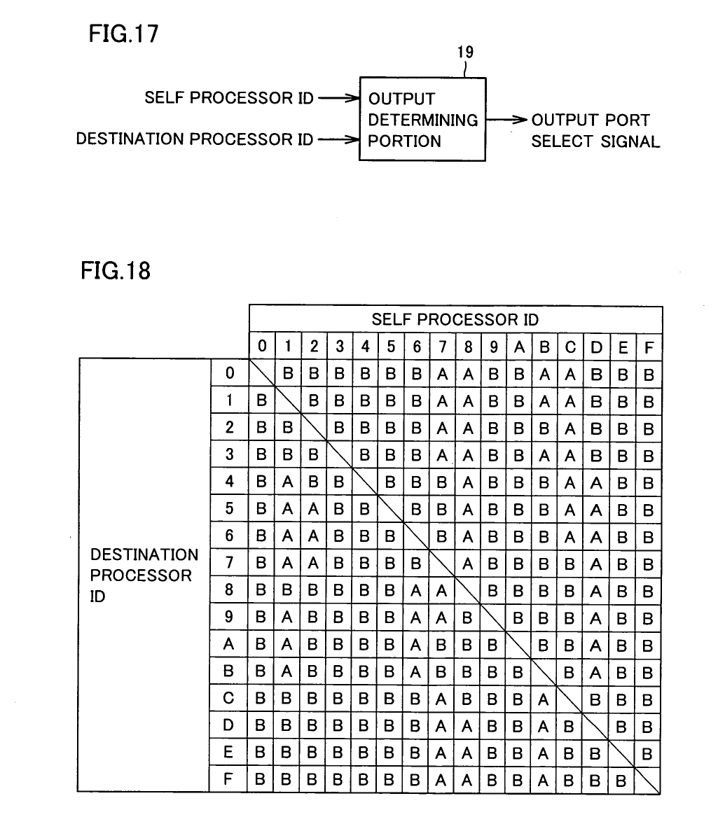

FIG. 17 illustrates an example of a structure of output determining portion 19. After the processor ID of each processor is determined by the operations already described with reference to FIGS. 8-16, the optimum path from each processor to a given processor can be determined. More specifically, output determining portion 19 refers to the truth table held therein, and produces, based on the self processor ID and the destination processor ID, the output port select signal for selecting the output port used for outputting the data packet, and this signal is provided to diverging portion 21.

FIG. 18 illustrates an example of the truth table used for selecting the output port. In this truth table, “A” indicates that output port A is to be selected, and “B” indicates that output port B is to be selected. For example, when the data packet is to be transmitted from processor 1-0 of processor ID “0” to the processor of processor ID “4”, output determining portion 19 of processor 1-0 provides the data packet to output port OB because the self processor ID is “0”, and the destination processor ID is “4”. Output determining portion 19 of processor 1-1 provides the data packet to output port OA because the self processor ID is “1”, and the destination processor ID is “4”. In this manner, the data packet is transmitted from the processor of processor ID “0” to the processor of processor ID “4”.

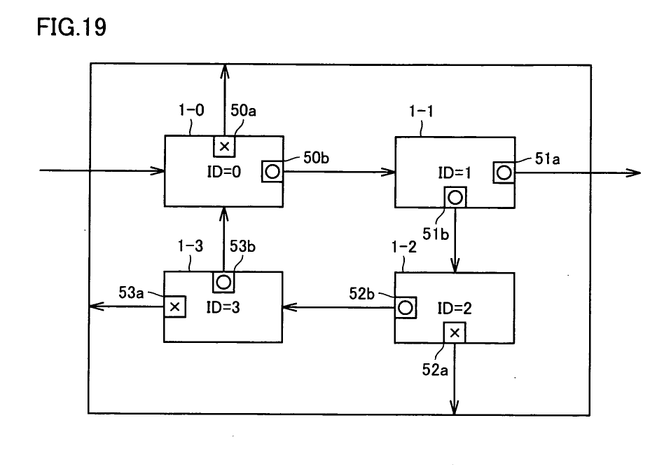

FIG. 19 illustrates a connection state of output ports of each processor. The processor receives a corresponding Ready signal on its output port, and outputs the data packet. This Ready signal is output from the processor having the output port in the connected state, and indicates whether the processor is ready to receive the data packet or not. When the output port is not connected to any processor, handshake cannot be performed during the initializing operation when starting the processor. Thus, output determining portion 19 refers to this Ready signal, and determines that the output port is not connected to the processor when the Ready state is not attained for a predetermined time.

The data-driven processor uses a C element, and the data packet cannot be output from the output port if a transfer enable input terminal RI is fixed to the disabled state (at an “L” level). It is possible to detect that the output port is not connected to the processor when it is detected, in the initializing operation, that the RI terminal is at the “L” level for a certain time. Details of this operation of the C-element are disclosed in the U.S. Patent Application Publication No. US2005/0210305 of the same assignee.

As illustrated in FIG. 19, output determining portion 19 stores the information specifying the processor connected to the output port in connection state register 20. For example, output port OA (50a) of processor 1-0 is not connected to the processor, and output port OB (50b) is connected to the processor so that connection state register 20 of processor 1-0 stores the information about these connection states.

When the transmission data packet arrives at the disabled output port, output determining portion 19 returns, as an error, this data packet to the processor of the sender. The processor may be internally provided with a transfer host register (not illustrated), and the error packet may be transmitted to a processor specified by the transfer host register.

When the processor of the destination is not directly connected to the disabled output port, but is connected to the port beyond it, the data packet is provided to the output port other than the disabled output port, whereby the data packet can be transmitted to the intended processor by detouring the disabled output port.

Also, a bit indicating the disabled state may be set in connection state register 20 corresponding to the output port connected to the processor in which a failure is detected by a test program, whereby the data packet can be transmitted by detouring the failed processor, and the failed processor can be isolated. Thereby, the multiprocessor can continue the processing without stopping.

Processor ID register 13 or an SRAM (Static Random Access Memory) may be used as a portion for storing the processor ID, in which case the setting can be erased when the power of the processor is turned off so that the processor ID is automatically set even when the configuration of the multiprocessor is changed.

A flash memory or an EEPROM (Electrically Erasable and Programmable Read Only Memory) may be used as a portion for storing the processor ID, in which case the setting is not erased even when the power of the processor is turned off. Therefore, resetting of the processor ID is not required, and the operation can be performed rapidly.

According to the processor of the embodiment, as described above, ID determining portion 12 determines the processor ID of this processor based on the name of the input port receiving control instruction B and the sender processor ID stored in received control instruction B. Therefore, the processor ID of each processor can be automatically determined during the initializing processing.

Output determining portion 19 refers to the truth table held therein, and thereby determines the optimum path of the data packet to the destination based on the self processor ID and the destination processor ID. Therefore, resetting for the path selection is not required even when the processor ID is changed, e.g., due to later addition of the processors.

When the output port to be connected to the destination is not connected, output determining portion 19 handles the current data packet as an error, and transmits it to the sender or a predetermined processor. Therefore, the system can readily perform the error processing.

Since output determining portion 19 outputs the data packet by referring to the connection state of each output port stored in connection state register 20, the data packet can be transmitted by detouring the disabled output port and the failed processor.

For example, the four processors form the multiprocessor at the first level, and the four multiprocessors at the second level form the multiprocessor at the third level. Thus, the four processors are handled as a basic unit, and the multiprocessor is formed of the units of 4^{N} (N=1, 2, 3, . . . ) in number. Therefore, the processors can be readily added to the multiprocessor.

(Second Embodiment)

In a data-driven-type processor of a second embodiment of the invention differs from the data-driven-type processor of the first embodiment illustrated in FIG. 3 only in the internal structure of output determining portion 19. Therefore, description of the same structures and functions is not repeated.

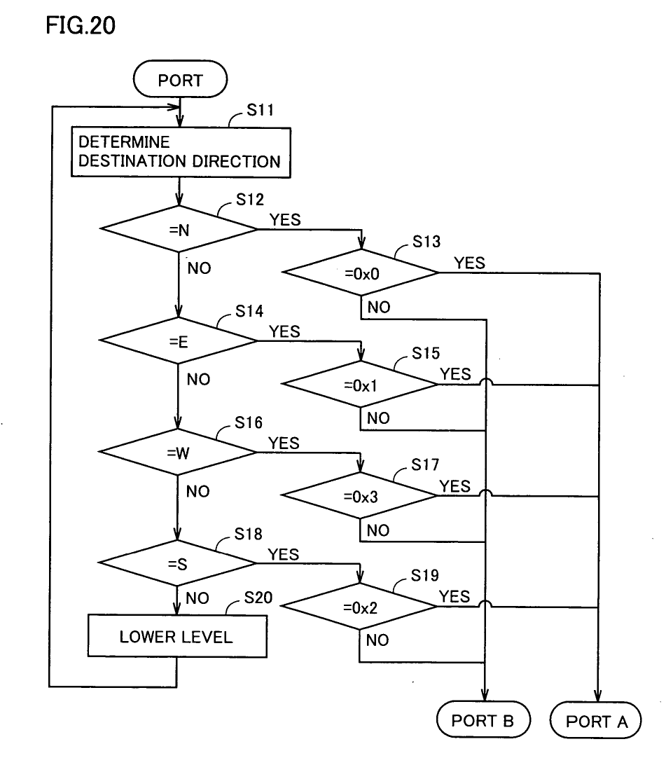

FIG. 20 is a flowchart illustrating processing steps of output determining portion 19 in the second embodiment of the invention. Output determining portion 19 first determines the destination direction from the highest level of the hierarchy, and will successively determines the destination directions while lowering the levels. In this manner, output determining portion 19 will finally transmit the data packet to the destination processor at the first level.

According to the self processor ID and the processor ID of the destination, output determining portion 19 determines the destination direction N, E, W or S at the highest level (step S11).

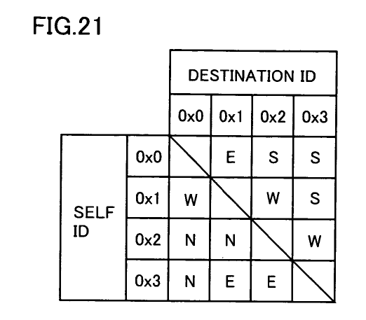

FIG. 21 illustrates an example of the truth table used for determining the destination direction. In this truth table, two bits corresponding to the current level in the self processor ID are handled as the self ID, the two bits corresponding to the current level in the destination processor ID are handled as the destination ID, and thereby the destination direction is determined. For example, when the self processor ID is “0xC1” and the destination processor ID is “0x46”, the self ID at the highest level is “0x3”, and the destination ID is “0x1”. In this case, it is determined that the destination direction is E (right).

When the destination direction is N (up) (Yes in step S12), output determining portion 19 determines whether the self ID at the first level of the self processor ID is “0x0” or not (step S13). For example, when the selfprocessor ID is “0xC1”, the self ID at the first level is “0x1”. When the self ID at the first level is “0x0” (Yes in step S13), output port OA is selected. When the self ID at the first level is not “0x0” (No in step S13), output port OB is selected.

When the destination direction is E (right) (Yes in step S14), output determining portion 19 determines whether the self ID at the first level of the self processor ID is “0x1” or not (step S15). When the self ID at the first level is “0x1” (Yes in step S15), output port OA is selected. When the self ID at the first level is not “0x1” (No in step S15), output port OB is selected.

When the destination direction is W (left) (Yes in step S16), output determining portion 19 determines whether the self ID at the first level of the self processor ID is “0x3” or not (step S17). When the self ID at the first level is “0x3” (Yes in step S17), output port OA is selected. When the self ID at the first level is not “0x3” (No in step S17), output port OB is selected.

When the destination direction is S (down) (Yes in step S18), output determining portion 19 determines whether the self ID at the first level of the self processor ID is “0x2” or not (step S17). When the self ID at the first level is “0x2” (Yes in step S19), output port OA is selected. When the self ID at the first level is not “0x2” (No in step S19), output port OB is selected.

When the self ID matches with the destination ID at the highest level (No in step S18), the destination processor belongs to the same group at the highest level. Therefore, the level is lowered by one (step S20), and the processing in and after step S11 is repeated. When the current level is the first level, this means that the data packet arrives at the destination processor.

According to the processor of the embodiment, as described above, the destination direction is determined with reference to the truth table at each level, and the output port is determined according to this destination direction and the value at the first level of the self processor ID. Therefore, even when the number of levels of the multiprocessors increases, the same circuit can be used for storing the truth table. If the truth table is stored, e.g., in a ROM, the capacity of the ROM can be lower than that in the first embodiment.

Even when the structure of the multiprocessor is to be changed, it is not necessary to change the structure of output determining portion 19.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A processor for forming a multiprocessor, comprising:
at least one set of input/output ports;
an identifier determining portion determining a self processor identifier based on a processor identifier of a first different processor connected to said input port provided from said first different processor; and
an operation processing portion performing an operation on data included in a data packet of a destination of the self processor identifier determined by said identifier determining portion, and producing a data packet including a result of the operation, wherein
said output port provides the data packet produced by said operation processing portion to a second different processor connected to said output port.

2. The processor according to claim 1, wherein
said processor includes two sets of the input/output ports, and
said identifier determining portion determines said self processor identifier based on the processor identifier of said first different processor and information specifying the input port selected from between said two input ports for inputting the processor identifier of said first different processor.

3. The processor according to claim 2, further comprising:
an output determining portion determining the output port to be selected from between the two output ports for outputting said data packet, based on said self processor identifier and a destination processor identifier included in said data packet.

4. The processor according to claim 3, further comprising:
a storing portion storing information indicating whether each of said two output ports is connected to a different processor or not, and
when said output determining portion determines according to the information stored in said storing portion that the output port selected for outputting the data packet is not connected, said output determining portion outputs said data packet via the other output port.

5. The processor according to claim 4, wherein
when said output determining portion determines that the different processor connected to the output port is failed, said output determining portion stores, in said storing portion, information indicating that the output port connected to said different processor is not connected.

6. The processor according to claim 3, further comprising:
a storing portion storing information indicating whether each of said two output ports is connected to a different processor or not, wherein
said output determining portion transmits a packet indicating an error to a processor of a sender when said output determining portion refers to said storing portion and determines that the output port connected to the processor of the destination of the data packet is not connected.

7. The processor according to claim 3, further comprising:
a storing portion storing information indicating whether each of said two output ports is connected to a different processor or not, wherein
said output determining portion transmits a packet indicating an error to a predetermined processor when said output determining portion refers to said storing portion and determines that the output port connected to the processor of the destination of the data packet is not connected.

8. A multiprocessor forming method for forming a multiprocessor by connecting a plurality of processors each having at least one set of input/output ports, comprising the steps of:
causing a first processor to determine a self processor identifier of the first processor based on a processor identifier of a second processor received from said second processor connected to said input port of said first processor; and
causing said first processor to transmit said determined self processor identifier to a third processor connected to said output port of said first processor.

9. The multiprocessor forming method according to claim 8, wherein
said multiprocessor includes a multiprocessor at a first level formed of annularly connected four processors each having two sets of input/output ports and a multiprocessor at a second level formed of an annularly connected four multiprocessors at the first level, and has a hierarchical structure of units of 4^{N} in number, and N is an integer larger than 0.

10. The multiprocessor forming method according to claim 9, wherein a position of the processor included in the multiprocessor at the first level is represented by 2 bits, a position of the multiprocessor at the first level included in the multiprocessor at the second level is represented by 2 bits, and a processor identifier of the multiprocessor at the Nth level is represented by (2×N) bits.

11. The multiprocessor forming method according to claim 10, wherein each of the processors forming said multiprocessor determines a destination direction by successively making a comparison between the self processor identifier and a destination processor identifier included in a received packet in a direction from an upper level to a lower level, and determines the output port according to said destination direction and a value at the first level of said self processor identifier.
